(19) United States
(12) Patent Application Publication
(10) Pub. No.: US 2004/0227594 A1
(43) Pub. Date: Nov. 18, 2004

(54) High quality resonant circuit based on tuning of bonding wire inductances

(75) Inventor: David H. Shen, Saratoga, CA (US)

Correspondence Address: DAVID H. SHEN, IRF Semiconductor, Inc., 6 RESULTS WAY, CUPERTINO, CA, 95014, US

(73) Assignee: IRF SEMICONDUCTOR, INC.

(21) Appl. No.: 10/729,643

(22) Filed: Dec. 5, 2003

Related U.S. Application Data
(60) Provisional application No. 60/431,978, filed on Dec. 10, 2002.

(51) Int. Cl. H01P 7/06

(52) U.S. Cl. 333/231; 333/17.1

(57) ABSTRACT

A method for tuning a high quality resonant circuit based on bonding wire inductors and tunable capacitors is disclosed which permits greater integration on standard silicon chips and greater insensitivity to manufacturing and ambient temperature variations. The L-C resonant circuit is tuned by a phase-locked loop with an L-C based VCO. Bonding wire inductors can be used in the resonant circuit in order to enhance the quality factor, and manufacturing variations of the bonding wire inductors are compensated by the tuning circuit. The L-C resonant circuit can be operated continuously with the tuning circuit turned off.

### THIS APPLICATION IS BASED ON THE PROVISIONAL APPLICATION NO. 60/431978 FILED ON DEC. 10, 2002

### REFERENCE:

[1] Li, D. & Tsividis Y., Dig. of Tech. Papers, International Solid-State Circuits Conference, Feb. 2001, pp 368-369.

### BACKGROUND

1. Technical Field of Invention

The present invention relates to a method of integrating accurate and high quality integrated L-C filters by using a tuning mechanism to compensate for manufacturing and ambient temperature variations of bonding wire inductors and on-chip capacitors. These tuned filters can find applications in integrated radio frequency receiver and transmitters.

2. Background of the Invention and Discussion of Prior Art

At the present time, one of the main barriers in integrating RF communications receivers is the inability to manufacture high quality filters repeatedly with accurate cut-off frequencies. FIG. 1 describes a parallel resonant circuit with a capacitor, 1, and inductor, 2. The resonant circuit is acts as high impedance at a single frequency so that a current input, 4, can be converted to a voltage output, 3, with high gain at a single tuned frequency. However, integrated circuit inductors have large series resistance that limit the quality factor that can be obtained by the resonant circuit. The use of bonding wire inductors from packaging is also known in the art to improve the quality factor of the resonant circuit. However, bonding wire inductors have large variations in manufacturing that prevent accurate and repeatable manufacturing of a fixed inductance. In addition, the processing of capacitors in integrated circuits will also have significant manufacturing process variations. These variations prevent a fixed resonant response from being consistently and accurately manufactured.

One method of tuning L-C filtering based on time multiplexing between a tuning circuit and a filtering circuit has been described in [1]. This method relies on matching of inductors between a tuning circuit and the filter circuit. In package bonding wires, it is not possible to match bonding wire lengths, and hence inductor values accurately, so this method will not be effective. Additionally, the time multiplexing of the tuning circuit prevents the filter from being usable for continuous data.

### OBJECTS AND ADVANTAGES OF THE INVENTION

Accordingly, it is a primary object of the present invention to provide a self-tuning L-C circuit topology that can be used with the high quality factor of bonding wire inductors, but is insensitive to manufacturing and ambient temperature variations and is able to operate continuously.

### SUMMARY OF THE INVENTION

The present invention achieves the above objects and advantages by providing a new method for designing a high quality, bonding wire based L-C circuit capable of maintaining a continuous filter response without sensitivity to manufacturing and ambient temperature variations.

### DESCRIPTION OF DRAWINGS

FIG. 1 is a diagram of a prior art L-C resonant circuit.

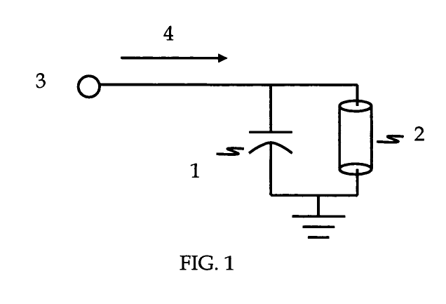

FIG. 2 is a block diagram of the self-tuning L-C resonant circuit.

FIG. 3 is an example of the active transconductance elements of the VCO.

FIG. 4 is an example of a tunable resonant circuit.

### DESCRIPTION OF THE PREFERRED EMBODIMENT

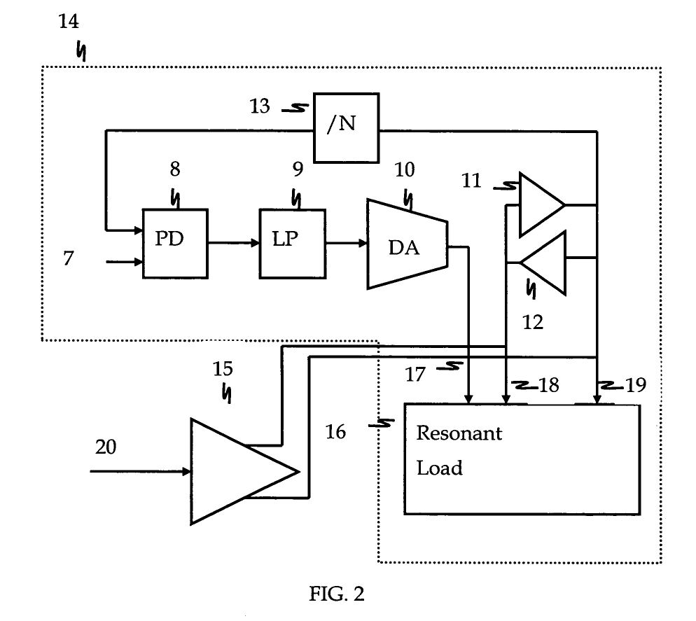

FIG. 2 is a block diagram of the self-tuning L-C filter consisting of a resonant circuit, 16, which is tunable, based on tuning voltage, 17. A transconductance amplifier stage, 15, amplifies input signal, 20, and drives a current into the resonant circuit at nodes 18 and 19. A filtered and amplified version of the input signal appears as an output voltage across nodes 18 and 19. In order to compensate for processing variations, a phase-locked loop, 14, forms the basis of the L-C tuning circuit. The phase-locked loop, 14, consists of a reference frequency input, 7, phase detector, 8, digital loop filter, 9, digital-to-analog converter, 10, frequency divider, 13, and L-C based voltage-controlled oscillator (VCO) consisting of a active transconductance amplifiers, 11 and 12, with a resonant load, 16. The operation of phase-locked loops is well known in the art. The phase-frequency detector, 8, compares the frequency of the reference frequency input, 7, with the output of the frequency divider, 13. The digital loop filter, 9, integrates the error signal from the phase-frequency detector, 8. The digital output of the digital loop filter, 9, is then used to drive the input of the digital-to-analog converter, 10. The analog output of the digital-to-analog converter, 10, drives the tuning voltage, 17, of the resonant circuit, 16. After the phase-locked loop is powered up and locked, it is shut down. The value of the digital loop filter is saved in digital registers to control the value of the tuning voltage, 17, of the resonant circuit. Shutting down the tuning loop allows the properly tuned resonant circuit to be used as a load of the transconductance amplifier, 15. The amplified and filtered outputs of the circuits are nodes 18 and 19.

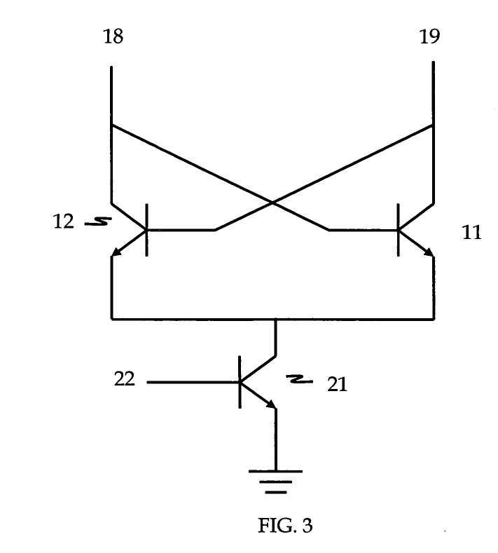

FIG. 3 is a diagram of a possible implementation of the active transconductance elements, 11 and 12, of the VCO. The VCO consists of active transistors, 11 and 12, such as bipolar or MOS transistors, forming the transconductance amplifiers for the VCO. A tail current source, 21, is controlled by bias voltage, 22. Bias voltage, 22, can be used to power down the VCO when the PLL is shut down. The resonant load is connected at nodes 18 and 19. Those skilled in the art will recognize that there are many possible implementations of the VCO that are still covered by the scope of the present invention.

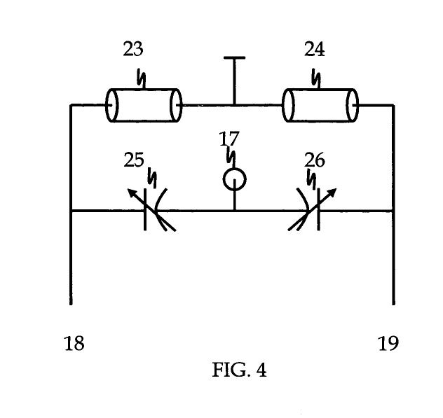

FIG. 4 is a diagram of one possible resonant circuit 16 that can be used as the VCO load and the transconductance amplifier, 15, load. The resonant circuit consists of inductors, 23 and 24, and tunable capacitors, 25 and 26. The tuning voltage, 17, adjusts the values of the capacitors, 25 and 26, so that the resonant circuit is tuned to the desired center frequency. The inductors, 23 and 24, can be implemented as on-chip spiral inductors, or as bonding wire inductors for higher quality factor. The tunable capacitors, 25 and 26, can be implemented as junction varactors or MOS varactors. Those skilled in the art will recognize that there are many possible L-C resonant circuit networks that can be designed with fewer or more inductors, capacitors, or resistors than the preferred embodiment.

These and other modifications, which are obvious to those skilled in the art, are intended to be included within the scope of the present invention. Accordingly, the scope of the invention should be determined not by the embodiment described, but by the appended claims and their legal equivalents.

1. A method for self-tuning an L-C filter resonant circuit comprising
A phase-frequency detector with a fixed reference frequency input and a frequency-divided oscillator input. The output of the phase detector is connected to
A digital loop filter whose output is connected to
A digital-to-analog converter that generates a voltage to tune the capacitors of
An L-C filter that is the load of the active transconductors of a VCO and the load of a transconductance amplifier,
A transconductance amplifier that amplifies and filters an input signal.
A frequency divider whose output connects to an input of the phase detector.

2. The method of claim 1 wherein the tunable capacitors are based on varactors.

3. The method of claim 1 wherein the tunable capacitors are based on MOS capacitors.

4. The method of claim 1 wherein the inductors are based on on-chip spiral inductors.

5. The method of claim 1 wherein the inductors are based on bonding wires.

6. The method of claim 1 wherein the L-C filter is a ladder type.

7. The method of claim 1 wherein the L-C filter is a two-pole resonant circuit.

8. The method of claim 1 wherein the L-C filter forms a band-pass filter.

9. The method of claim 1 wherein the L-C filter is used in a radio frequency system.

10. The method of claim 1 wherein the circuits are implemented in a CMOS technology.

11. The method of claim 1 wherein the circuits are implemented in a bipolar technology.

12. The method of claim 1 wherein the circuits are implemented in other semiconductor process technologies.

13. The method of claim 1 wherein the digital loop filter is implemented by a digital counter.

14. The method of claim 1 wherein the L-C filter includes resistors.

15. The method of claim 1 wherein the number of capacitor elements in the L-C filter are N, where N is an integer.

16. The method of claim 1 wherein the number of inductor elements in the L-C filter are M, where M is an integer.

17. The method of claim 1 wherein the number of resistor elements in the L-C filter are J, where J is an integer.

18. The method of claim 1 wherein the tuning voltage is used to control multiple L-C filter networks.

19. The method of claim 1 wherein the circuits are fully differential.

20. The method of claim 1 wherein the circuits are single-ended.
